(19) United States
(12) Patent Application Publication
(10) Pub. No.: US 2026/0124527 A1
(43) Pub. Date: May 7, 2026

(54) BUTTON STRUCTURE

(71) Applicant: CHENG UEI PRECISION INDUSTRY CO., LTD., New Taipei City (TW)

(72) Inventor: TSUNG-SHIH LEE, New Taipei City (TW)

(21) Appl. No.: 19/198,074

(22) Filed: May 4, 2025

(30) Foreign Application Priority Data
Nov. 7, 2024 (CN) 202422706862.8

(51) Int. Cl. A63F 13/24

(52) U.S. Cl. CPC A63F 13/24

(57) ABSTRACT

A button structure includes a pressing button, a conductive film, a bracket, a circuit board and a metal elastic element. The pressing button has a pressing portion. A middle of an upper portion of a rear surface of the pressing portion extends rearward to form a triggering portion. A middle of a lower portion of the rear surface of the pressing portion extends rearward to form an extending portion. The conductive film is disposed to an inner surface of the pressing portion. The bracket is mounted to a rear of the pressing button. The circuit board is disposed on the bracket. The circuit board is equipped with a switch. The triggering portion is corresponding to the switch. The metal elastic element is disposed between the pressing button and the bracket.

### CROSS REFERENCE TO RELATED APPLICATIONS

The present application is based on, and claims priority from, China Patent Application No. 202422706862.8, filed Nov. 7, 2024, the disclosure of which is hereby incorporated by reference herein in its entirety.

### BACKGROUND OF THE INVENTION

### Field of the Invention

The present invention generally relates to a button structure, and more particularly to a button structure which is capable of simplifying mechanism parts, simplifying an assembling process, reducing a manufacturing cost and having a touch sensing function.

### Description of Related Art

Generally, shoulder keys in a game controller are acted as more frequently used operating keys. The shoulder keys are symmetrically disposed to two opposite sides of a front end of the game controller. The shoulder keys are pressed by index fingers to operate the game controller. The shoulder keys are rebounded to be restored to original positions by resilience forces of the shoulder keys and structure strengths of the shoulder keys. A length of each shoulder key is relatively longer, and a production tolerance and an assembling tolerance are generated between the shoulder keys and other various structures of the game controller, so a distance is formed between the shoulder keys and an electronic component of the game controller when the shoulder keys are pressed downward, and a larger gap is formed between a contacting point of each shoulder key and the electronic component of the game controller. As a result, the shoulder keys have a poor usage hand feeling.

A conventional game pad includes a button assembly, a switch assembly and a button bracket. The switch assembly is disposed to the button bracket. The switch assembly and the button assembly are cooperated with each other. The button assembly has a shaft. The button bracket has a button fixing structure. A shape of the button fixing structure is matched with a shape of the shaft. The shaft is buckled in the button fixing structure, so that the button assembly is rotatably connected with the button bracket.

However, one end of a compression spring of the button assembly of the conventional game pad is disposed in a button sleeve, and the other end of the compression spring of the button assembly of the conventional game pad is disposed to a spring blocking wall. The button sleeve and the spring blocking wall are limited by the compression spring. The button sleeve and the spring blocking wall are arranged in a linear direction of the compression spring, so an internal structure of the button assembly of the conventional game pad is relatively complicated, an assembling process of the internal structure of the button assembly is relatively complicated, and the internal structure of the button assembly has a higher manufacturing cost. In addition, the button assembly of the conventional game pad lacks a touch sensing function for detecting an approaching finger.

Thus, it is essential to provide an innovative button structure, the innovative button structure which is capable of simplifying mechanism parts, simplifying an assembling process, reducing a manufacturing cost and having a touch sensing function.

### BRIEF SUMMARY OF THE INVENTION

An object of the present invention is to provide a button structure which is capable of simplifying mechanism parts, simplifying an assembling process, reducing a manufacturing cost and having a touch sensing function. The button structure includes a pressing button, a conductive film, a bracket, a circuit board and a metal elastic element. The pressing button has a pressing portion. A middle of an upper portion of a rear surface of the pressing portion extends rearward to form a triggering portion. A middle of a lower portion of the rear surface of the pressing portion extends rearward to form an extending portion. The triggering portion is disposed to one side of the extending portion. A top surface of the extending portion extends upward to form a buckling portion. The conductive film is disposed to an inner surface of the pressing portion. The conductive film covers a top surface of the extending portion. The conductive film is mounted around the buckling portion. The bracket is mounted to a rear of the pressing button. A bottom surface of the bracket extends downward to form a locating pillar. The bracket has a through hole penetrating through a top surface and the bottom surface of the bracket. The through hole is formed to one side of the locating pillar. The circuit board is mounted to the rear of the pressing button. The circuit board is disposed on the bracket. The circuit board is equipped with a switch. The triggering portion is corresponding to the switch. The metal elastic element is disposed between the pressing button and the bracket. The metal elastic element has at least two main bodies, and a connecting portion disposed between the at least two main bodies. Two opposite ends of the connecting portion are connected with the at least two main bodies, respectively. The connecting portion is fastened to the bottom surface of the bracket. One end of one main body is mounted around the buckling portion. The other end of the one main body is mounted around the locating pillar. The other main body is disposed in the through hole. A top end of the other main body passes through the through hole, and the top end of the other main body is electrically connected with the circuit board.

Another object of the present invention is to provide a button structure. The button structure includes a bracket, a pressing button, a conductive film, a circuit board and a metal elastic element. The bracket has a first surface and a second surface which are opposite to each other, and the bracket has a through hole penetrating through the first surface and the second surface. The pressing button is disposed to a front of the bracket. The pressing button has a pressing portion. A middle of an upper portion of a rear surface of the pressing portion extends rearward to form a triggering portion. A lower portion of the rear surface of the pressing portion extends rearward to form a fastening portion. The fastening portion faces the first surface of the bracket. The conductive film is disposed to an inner surface of the pressing portion, and the conductive film covers an upper surface of the fastening portion. The circuit board is disposed to the second surface of the bracket. The circuit board is equipped with a switch. The triggering portion is corresponding to the switch. The metal elastic element is disposed in the through hole. One end of the metal elastic element protrudes beyond the first surface of the bracket, and the one end of the metal elastic element is fastened to the fastening portion. The one end of the metal elastic element is connected with the conductive film. The other end of the metal elastic element passes through the through hole, and the other end of the metal elastic element is connected with the circuit board.

Another object of the present invention is to provide a button structure. The button structure includes a bracket, a locking element, a pressing button, a conductive film, a circuit board and a metal elastic element. The bracket has a first surface and a second surface which are opposite to each other. The first surface extends downward to form a locating pillar, a location portion and a protruding portion. The bracket has a through hole and a locating hole. The location portion and the protruding portion are formed between the locating pillar and the through hole. The locating hole is formed in the location portion. The locking element is fastened in the locating hole. The locking element abuts against the location portion and the protruding portion. The pressing button is disposed to a front of the bracket. The pressing button has a pressing portion. The pressing portion has a triggering portion and a fastening portion. The conductive film covers the fastening portion. The circuit board is disposed to the second surface of the bracket. The circuit board is equipped with a switch. The triggering portion is corresponding to the switch. The metal elastic element is disposed in the through hole. One end of the metal elastic element protrudes beyond the first surface of the bracket, and the one end of the metal elastic element is fastened to the fastening portion. The one end of the metal elastic element is electrically connected with the conductive film. The other end of the metal elastic element passes through the through hole, and the other end of the metal elastic element is electrically connected with the circuit board.

As described above, the metal elastic element has a wider portion of a first main portion, a narrower portion of the first main portion, a second main portion and the connecting portion, a bottom end of the wider portion is mounted around the buckling portion of the pressing button, and a top end of the narrower portion is mounted around the locating pillar of the bracket. Furthermore, the connecting portion is fastened to the bottom surface of the bracket, the second main portion is disposed to one side of the wider portion and one side of the narrower portion, a top end of the second main portion passes through the through hole, the top end of the second main portion protrudes beyond the top surface of the bracket, and the top end of the second main portion is electrically connected with a bottom surface of the circuit board. As a result, the button structure operates in a non-linear manner to achieve effects of simplifying the mechanism parts, simplifying the assembling process and reducing the manufacturing cost, and the button structure has the touch sensing function.

### BRIEF DESCRIPTION OF THE DRAWINGS

The present invention will be apparent to those skilled in the art by reading the following description, with reference to the attached drawings, in which:

FIG. 1 is a perspective view of a button structure in accordance with a preferred embodiment of the present invention;

FIG. 2 is a partially exploded view of the button structure of FIG. 1;

FIG. 3 is another partially exploded view of the button structure of FIG. 1;

FIG. 4 is an exploded view of the button structure of FIG. 1; and

FIG. 5 is a perspective view of a metal elastic element of the button structure of FIG. 1.

### DETAILED DESCRIPTION OF THE INVENTION

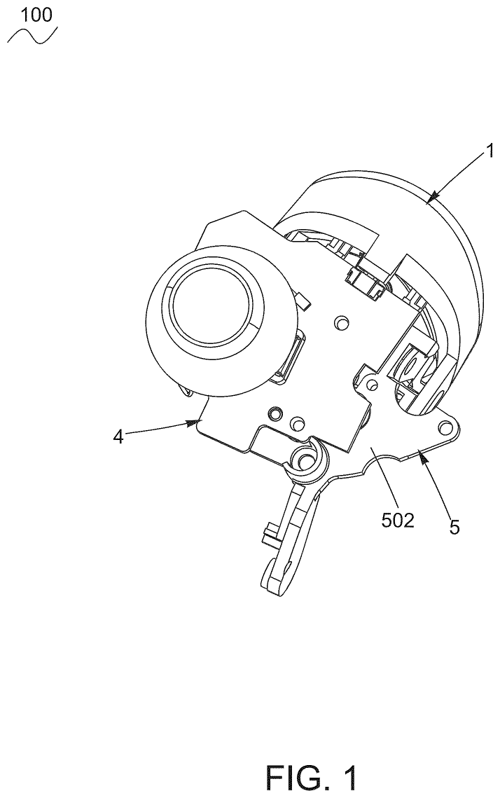

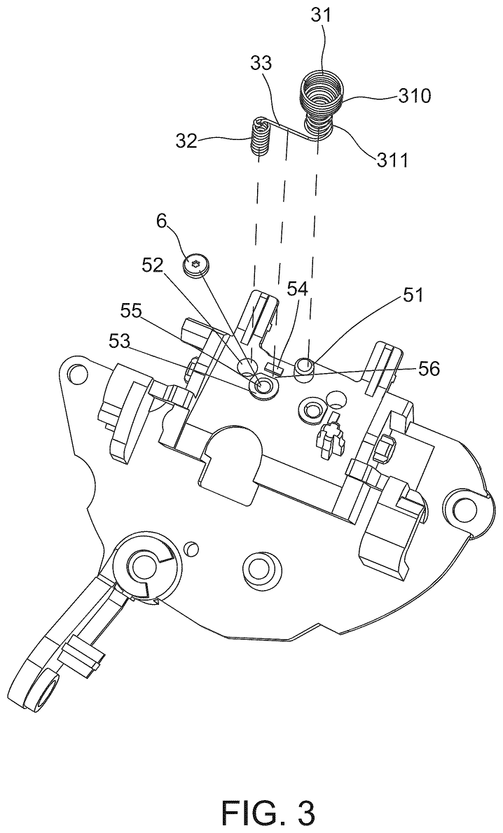

With reference to FIG. 1 to FIG. 4, a button structure 100 according to a preferred embodiment of the present invention is shown. The button structure 100 includes a pressing button 1, a conductive film 2, a metal elastic element 3, a circuit board 4 and a bracket 5.

The pressing button 1 is disposed to a front of the bracket 5. The bracket 5 is mounted to a rear of the pressing button 1. The pressing button 1 is disposed to a front of the circuit board 4. The circuit board 4 is mounted to the rear of the pressing button 1. In the preferred embodiment, the conductive film 2 is adhered to an inner surface of the pressing button 1. In a concrete implementation, the conductive film 2 is without being limited to be adhered to the inner surface of the pressing button 1. The conductive film 2 is formed on the inner surface of the pressing button 1 by a laser engraving way, or the conductive film 2 is electroplated on the inner surface of the pressing button 1. The circuit board 4 is disposed on the bracket 5. The metal elastic element 3 is disposed between the pressing button 1 and the bracket 5. Two opposite ends of the metal elastic element 3 are fastened to a rear end of a lower portion of the pressing button 1 and a bottom surface of the circuit board 4, respectively.

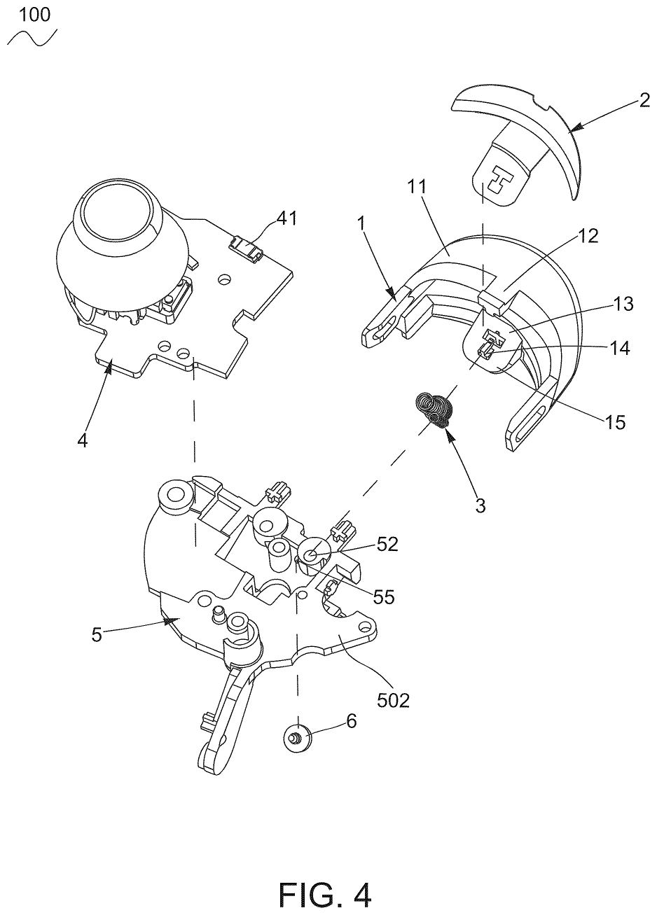

Referring to FIG. 4, the pressing button 1 has a pressing portion 11, a triggering portion 12, an extending portion 13 and a buckling portion 14. The pressing portion 11 is disposed to a front end of the bracket 5. A middle of an upper portion of the rear surface of the pressing portion 11 extends rearward to form the triggering portion 12. A lower portion of the rear surface of the pressing portion 11 extends rearward to form a fastening portion 15. A middle of the lower portion of the rear surface of the pressing portion 11 extends rearward to form the extending portion 13. The triggering portion 12 is disposed to one side of the extending portion 13. A top surface of the extending portion 13 extends upward to form the buckling portion 14. The conductive film 2 is disposed to the inner surface of the pressing portion 11 of the pressing button 1, and the conductive film 2 covers an upper surface of the fastening portion 15. The conductive film 2 covers the top surface of the extending portion 13.

In the preferred embodiment, the conductive film 2 is adhered to a lower portion of an inner surface of the pressing portion 11 and the top surface of the extending portion 13. The conductive film 2 is mounted around the buckling portion 14, so the buckling portion 14 has a conductive function. One end of the metal elastic element 3 is mounted around the buckling portion 14, and the one end of the metal elastic element 3 abuts against the conductive film 2, so the metal elastic element 3 contacts with the conductive film 2, and the metal elastic element 3 and the conductive film 2 are mutually conductive. In the preferred embodiment, the extending portion 13 and the buckling portion 14 together form the fastening portion 15.

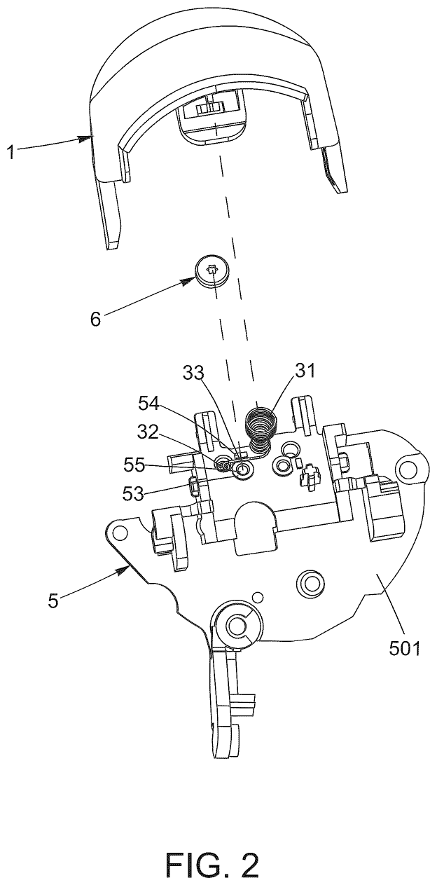

Referring to FIG. 2 to FIG. 5, the metal elastic element 3 has a first main portion 31, a second main portion 32 and a connecting portion 33. Two opposite sides of the metal elastic element 3 have the first main portion 31 and the second main portion 32. A center line of the first main portion 31 is deviated from a center line of the second main portion 32. The first main portion 31 has a wider portion 310 and a narrower portion 311. A bottom end of the wider portion 310 is mounted around the buckling portion 14 of the pressing button 1 to realize that the metal elastic element 3 is located to the pressing button 1, and the metal elastic element 3 is fixed to the pressing button 1. The bottom end of the wider portion 310 of the metal elastic element 3 abuts against the conductive film 2, so that the metal elastic element 3 contacts with the conductive film 2 which is disposed to the pressing button 1, and the metal elastic element 3 and the conductive film 2 which is disposed to the pressing button 1 are mutually conductive. A top end of the wider portion 310 extends upward to form the narrower portion 311. A top end of the narrower portion 311 is mounted around a corresponding mechanism of the bracket 5 to realize that the metal elastic element 3 is located to the bracket 5, and the metal elastic element 3 is fixed to the bracket 5.

The top end of the narrower portion 311 extends sideward and outward to form the connecting portion 33. The connecting portion 33 is disposed between the first main portion 31 and the second main portion 32. The connecting portion 33 is fastened to a bottom surface of the bracket 5. One end of the connecting portion 33 extends upward to form the second main portion 32. An outer end of the connecting portion 33 extends upward to form the second main portion 32. The second main portion 32 is disposed to one side of the first main portion 31. The second main portion 32 is disposed to one side of the wider portion 310 and one side of the narrower portion 311. The second main portion 32 is disposed in a corresponding position of the bracket 5. A top end of the second main portion 32 passes through the corresponding position of the bracket 5, and then the top end of the second main portion 32 is electrically connected with the bottom surface of the circuit board 4.

In the preferred embodiment, the wider portion 310 and the narrower portion 311 are roughly disposed along the same line. The wider portion 310 and the narrower portion 311 are roughly aligned along a longitudinal direction. The first main portion 31 and the second main portion 32 are located at different lines. The first main portion 31 and the second main portion 32 are unaligned along the longitudinal direction. The first main portion 31 and the second main portion 32 operate in a non-linear manner to achieve effects of simplifying mechanism parts, simplifying an assembling process and reducing a manufacturing cost.

In the preferred embodiment, an outer diameter of the wider portion 310 is bigger than an outer diameter of the narrower portion 311. The outer diameter of the narrower portion 311 is bigger than an outer diameter of the second main portion 32. The outer diameter of the wider portion 310, the outer diameter of the narrower portion 311 and the outer diameter of the second main portion 32 are differently used to enhance an operational hand feeling of the button structure 100. In the concrete implementation, the outer diameter of the wider portion 310, the outer diameter of the narrower portion 311 and the outer diameter of the second main portion 32 are the same.

Referring to FIG. 1 and FIG. 4, a front end of a top surface of the circuit board 4 is equipped with a switch 41. A rear end of the triggering portion 12 of the pressing button 1 is corresponding to the switch 41. A distance is formed between the switch 41 and the triggering portion 12 of the pressing button 1. When the pressing portion 11 of the pressing button 1 is pressed downward, the triggering portion 12 is pressed downward upon the switch 41 to generate a triggering signal. The triggering signal is transmitted to a processor of the game controller (not shown), so the processor of the game controller (not shown) executes instructions according to the triggering signal.

Referring to FIG. 2 to FIG. 5, the bracket 5 has a locating pillar 51, a through hole 52, a location portion 53, a protruding portion 54 and a locating hole 55. The bottom surface of the bracket 5 extends downward to form the locating pillar 51. The locating pillar 51 is corresponding to the buckling portion 14 of the pressing button 1. The top end of the narrower portion 311 of the metal elastic element 3 is mounted around the locating pillar 51 to realize that the metal elastic element 3 is located to the bracket 5, and the metal elastic element 3 is fixed to the bracket 5. The bracket 5 has the through hole 52 penetrating through a top surface and the bottom surface of the bracket 5. The through hole 52 is formed to one side of the locating pillar 51. The second main portion 32 of the metal elastic element 3 is disposed in the through hole 52. The top end of the second main portion 32 passes through the through hole 52, and the top end of the second main portion 32 protrudes beyond the top surface of the bracket 5. The top end of the second main portion 32 is electrically connected with the bottom surface of the circuit board 4.

The bottom surface of the bracket 5 extends downward to form the location portion 53. The location portion 53 is formed between the locating pillar 51 and the through hole 52. The bottom surface of the bracket 5 extends downward to form the protruding portion 54. The protruding portion 54 is formed between the locating pillar 51 and the through hole 52. In the preferred embodiment, the protruding portion 54 is formed in front of the location portion 53. In the concrete implementation, the protruding portion 54 is without being limited to be formed in front of the location portion 53. The locating hole 55 penetrates through the top surface and the bottom surface of the bracket 5. The locating hole 55 is formed in a middle of the location portion 53.

In the preferred embodiment, the button structure 100 includes a locking element 6. The locking element 6 is fastened in the locating hole 55. The location portion 53 is spaced from the protruding portion 54 to form a gap 56 between the location portion 53 and the protruding portion 54. The connecting portion 33 of the metal elastic element 3 is disposed in the gap 56. The locking element 6 covers the gap 56, and the locking element 6 fastens the connecting portion 33 of the metal elastic element 3 in the gap 56. The locking element 6 abuts against a bottom surface of the location portion 53 and a bottom surface of the protruding portion 54. A height of the location portion 53 is equal to a height of the protruding portion 54, so the locking element 6 is prevented from tilting. In the concrete implementation, the locking element 6 is able to fasten the connecting portion 33 of the metal elastic element 3 by a thermal fusion method.

In the preferred embodiment, the bottom surface of the bracket 5 is a first surface 501, the top surface of the bracket 5 is a second surface 502. The bracket 5 has the first surface 501 and the second surface 502 which are opposite to each other. The through hole 52 penetrates through the first surface 501 and the second surface 502 of the bracket 5. In the concrete implementation, the bottom surface of the bracket 5 is without being limited to be the first surface 501, and the top surface of the bracket 5 is without being limited to be the second surface 502. The fastening portion 15 faces the first surface 501 of the bracket 5. The circuit board 4 is disposed to the second surface 502 of the bracket 5.

The one end of the metal elastic element 3 protrudes beyond the first surface 501 of the bracket 5, and the one end of the metal elastic element 3 is fastened to the fastening portion 15. The one end of the metal elastic element 3 is connected with the conductive film 2. The other end of the metal elastic element 3 passes through the through hole 52, and the other end of the metal elastic element 3 is connected with the circuit board 4. The triggering portion 12 is corresponding to the second surface 502 of the bracket 5. The triggering portion 12 and the fastening portion 15 are fastened to two opposite ends of the rear surface of the pressing portion 11, respectively. A center line of the through hole 52 is inclined relative to the first surface 501 and the second surface 502 of the bracket 5. The first main portion 31 abuts between the fastening portion 15 and the first surface 501 of the bracket 5. The connecting portion 33 is fastened to the first surface 501 of the bracket 5. The first surface 501 of the bracket 5 extends downward to form the locating pillar 51. The first surface 501 of the bracket 5 extends downward to form the location portion 53 and the protruding portion 54. The location portion 53 and the protruding portion 54 are formed between the locating pillar 51 and the through hole 52. The locating hole 55 penetrates through the first surface 501 and the second surface 502 of the bracket 5. The top end of the second main portion 32 protrudes beyond the second surface 502 of the bracket 5.

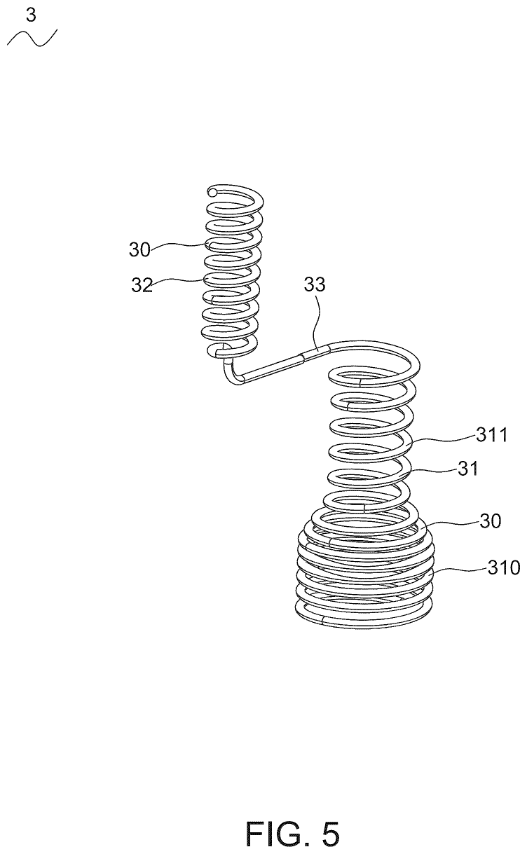

Referring to FIG. 5, the metal elastic element 3 has at least two main bodies 30. The wider portion 310 of the first main portion 31 of the metal elastic element 3, the narrower portion 311 of the first main portion 31 of the metal elastic element 3 and the second main portion 32 of the metal elastic element 3 together form the at least two main bodies 30. The connecting portion 33 of the metal elastic element 3 is disposed between the at least two main bodies 30. Two opposite ends of the connecting portion 33 of the metal elastic element 3 are connected with the at least two main bodies 30, respectively. One end of one main body 30 is mounted around the buckling portion 14 of the pressing button 1. The other end of the one main body 30 is mounted around the locating pillar 51 of the bracket 5.

Specifically, the one main body 30 is located below the other main body 30. A bottom end of the one main body 30 is mounted around the buckling portion 14 of the pressing button 1, and a top end of the one main body 30 is mounted around the locating pillar 51 of the bracket 5. The other main body 30 is disposed in the through hole 52 of the bracket 5. A top end of the other main body 30 passes through the through hole 52, and the top end of the other main body 30 is electrically connected with the bottom surface of the circuit board 4. One end of the connecting portion 33 is connected with the top end of the one main body 30, and the other end of the connecting portion 33 is connected with a bottom end of the other main body 30.

As described above, the metal elastic element 3 has the wider portion 310 of the first main portion 31, the narrower portion 311 of the first main portion 31, the second main portion 32 and the connecting portion 33, the bottom end of the wider portion 310 is mounted around the buckling portion 14 of the pressing button 1, and the top end of the narrower portion 311 is mounted around the locating pillar 51 of the bracket 5. Furthermore, the connecting portion 33 is fastened to the bottom surface of the bracket 5, the second main portion 32 is disposed to one side of the wider portion 310 and one side of the narrower portion 311, the top end of the second main portion 32 passes through the through hole 52, the top end of the second main portion 32 protrudes beyond the top surface of the bracket 5, and the top end of the second main portion 32 is electrically connected with the bottom surface of the circuit board 4. As a result, the button structure 100 operates in the non-linear manner to achieve the effects of simplifying mechanism parts, simplifying the assembling process and reducing a manufacturing cost, and the button structure 100 has the touch sensing function.

What is claimed is:

1. A button structure, comprising:
a pressing button having a pressing portion, a middle of an upper portion of a rear surface of the pressing portion extending rearward to form a triggering portion, a middle of a lower portion of the rear surface of the pressing portion extending rearward to form an extending portion, the triggering portion being disposed to one side of the extending portion, a top surface of the extending portion extending upward to form a buckling portion;
a conductive film disposed to an inner surface of the pressing portion, the conductive film covering a top surface of the extending portion, the conductive film being mounted around the buckling portion;
a bracket mounted to a rear of the pressing button, a bottom surface of the bracket extending downward to form a locating pillar, the bracket having a through hole penetrating through a top surface and the bottom surface of the bracket, the through hole being formed to one side of the locating pillar;
a circuit board mounted to the rear of the pressing button, the circuit board being disposed on the bracket, the circuit board being equipped with a switch, the triggering portion being corresponding to the switch; and
a metal elastic element disposed between the pressing button and the bracket, the metal elastic element having at least two main bodies, and a connecting portion disposed between the at least two main bodies, two opposite ends of the connecting portion being connected with the at least two main bodies, respectively, the connecting portion being fastened to the bottom surface of the bracket, one end of one main body being mounted around the buckling portion, the other end of the one main body being mounted around the locating pillar, the other main body being disposed in the through hole, a top end of the other main body passing through the through hole, and the top end of the other main body being electrically connected with the circuit board.

2. The button structure as claimed in claim 1, wherein the metal elastic element has a first main portion, a second main portion and the connecting portion, the first main portion has a wider portion and a narrower portion, the wider portion, the narrower portion and the second main portion together form the at least two main bodies, a bottom end of the wider portion is mounted around the buckling portion, a top end of the wider portion extends upward to form the narrower portion, a top end of the narrower portion is mounted around the locating pillar, the top end of the narrower portion extends sideward and outward to form the connecting portion, one end of the connecting portion extends upward to form the second main portion, the second main portion is disposed to one side of the first main portion, a top end of the second main portion passes through the through hole, and the top end of the second main portion protrudes beyond the top surface of the bracket, the top end of the second main portion is electrically connected with a bottom surface of the circuit board.

3. The button structure as claimed in claim 2, wherein an outer diameter of the wider portion is bigger than an outer diameter of the narrower portion, the outer diameter of the narrower portion is bigger than an outer diameter of the second main portion.

4. The button structure as claimed in claim 2, wherein the bottom surface of the bracket extends downward to form a location portion, the location portion is formed between the locating pillar and the through hole, the bottom surface of the bracket extends downward to form a protruding portion, the protruding portion is formed between the locating pillar and the through hole, the protruding portion is formed in front of the location portion, a height of the location portion is equal to a height of the protruding portion.

5. The button structure as claimed in claim 4, wherein the location portion is spaced from the protruding portion to form a gap between the location portion and the protruding portion, the connecting portion is disposed in the gap.

6. The button structure as claimed in claim 5, further comprising a locking element, the bracket having a locating hole penetrating through the top surface and the bottom surface of the bracket, the locating hole being formed in a middle of the location portion, the locking element being fastened in the locating hole, the locking element fastening the connecting portion in the gap, the locking element abutting against a bottom surface of the location portion and a bottom surface of the protruding portion.

7. A button structure, comprising:
a bracket having a first surface and a second surface which are opposite to each other, and the bracket having a through hole penetrating through the first surface and the second surface;
a pressing button disposed to a front of the bracket, the pressing button having a pressing portion, a middle of an upper portion of a rear surface of the pressing portion extending rearward to form a triggering portion, a lower portion of the rear surface of the pressing portion extending rearward to form a fastening portion, the fastening portion facing the first surface of the bracket;
a conductive film disposed to an inner surface of the pressing portion, and the conductive film covering an upper surface of the fastening portion;
a circuit board disposed to the second surface of the bracket, the circuit board being equipped with a switch, the triggering portion being corresponding to the switch; and
a metal elastic element disposed in the through hole, one end of the metal elastic element protruding beyond the first surface of the bracket, and the one end of the metal elastic element being fastened to the fastening portion, the one end of the metal elastic element being connected with the conductive film, the other end of the metal elastic element passing through the through hole, and the other end of the metal elastic element being connected with the circuit board.

8. The button structure as claimed in claim 7, wherein the triggering portion is corresponding to the second surface of the bracket.

9. The button structure as claimed in claim 8, wherein the pressing portion is disposed to a front end of the bracket, the triggering portion and the fastening portion are fastened to two opposite ends of the rear surface of the pressing portion, respectively, a center line of the through hole is inclined relative to the first surface and the second surface of the bracket.

10. The button structure as claimed in claim 9, wherein two opposite sides of the metal elastic element have a first main portion and a second main portion, the first main portion abuts between the fastening portion and the first surface of the bracket, the second main portion is disposed in the through hole, a center line of the first main portion is deviated from a center line of the second main portion.

11. The button structure as claimed in claim 10, wherein the metal elastic element has a connecting portion disposed between the first main portion and the second main portion, the connecting portion is fastened to the first surface of the bracket.

12. The button structure as claimed in claim 11, wherein the first surface of the bracket extends downward to form a locating pillar, the through hole is formed to one side of the locating pillar.

13. The button structure as claimed in claim 12, wherein the first surface of the bracket extends downward to form a location portion and a protruding portion, the location portion and the protruding portion are formed between the locating pillar and the through hole, a height of the location portion is equal to a height of the protruding portion.

14. The button structure as claimed in claim 13, wherein the location portion is spaced from the protruding portion to form a gap between the location portion and the protruding portion, the connecting portion is disposed in the gap.

15. The button structure as claimed in claim 14, further comprising a locking element, the bracket having a locating hole penetrating through the first surface and the second surface of the bracket, the locating hole being formed in a middle of the location portion, the locking element being fastened in the locating hole.

16. The button structure as claimed in claim 12, wherein the first main portion has a wider portion and a narrower portion, a top end of the wider portion extends upward to form the narrower portion, a top end of the narrower portion is mounted around the locating pillar, the top end of the narrower portion extends sideward and outward to form the connecting portion, one end of the connecting portion extends upward to form the second main portion, the second main portion is disposed to one side of the first main portion, a top end of the second main portion passes through the through hole, and the top end of the second main portion protrudes beyond the second surface of the bracket, the top end of the second main portion is electrically connected with a bottom surface of the circuit board.

17. The button structure as claimed in claim 16, wherein an outer diameter of the wider portion is bigger than an outer diameter of the narrower portion, the outer diameter of the narrower portion is bigger than an outer diameter of the second main portion.

18. A button structure, comprising:
a bracket having a first surface and a second surface which are opposite to each other, the first surface extending downward to form a locating pillar, a location portion and a protruding portion, the bracket having a through hole and a locating hole, the location portion and the protruding portion being formed between the locating pillar and the through hole, the locating hole being formed in the location portion;
a locking element fastened in the locating hole, the locking element abutting against the location portion and the protruding portion;
a pressing button disposed to a front of the bracket, the pressing button having a pressing portion, the pressing portion having a triggering portion and a fastening portion;
a conductive film covering the fastening portion;
a circuit board disposed to the second surface of the bracket, the circuit board being equipped with a switch, the triggering portion being corresponding to the switch; and
a metal elastic element disposed in the through hole, one end of the metal elastic element protruding beyond the first surface of the bracket, and the one end of the metal elastic element being fastened to the fastening portion, the one end of the metal elastic element being electrically connected with the conductive film, the other end of the metal elastic element passing through the through hole, and the other end of the metal elastic element being electrically connected with the circuit board.

19. The button structure as claimed in claim 18, wherein the metal elastic element has a connecting portion, the location portion is spaced from the protruding portion to form a gap between the location portion and the protruding portion, the connecting portion is disposed in the gap, the locking element fastens the connecting portion in the gap.

20. The button structure as claimed in claim 18, wherein a height of the location portion is equal to a height of the protruding portion.
